(19) United States
(12) Patent Application Publication
(10) Pub. No.: US 2005/0067793 A1
(43) Pub. Date: Mar. 31, 2005

(54) Radial shaft seal and method for making same

(75) Inventors: Thomas Klenk, Eppelheim (DE); Ulrich Liedtke, Laudenbach (DE); Frank Schultz, Mannheim (DE); Eberhard Bock, Morlenbach (DE); Stephan Wetzel, Groxheimertal (DE)

Correspondence Address: HARNESS, DICKEY & PIERCE, P.L.C., P.O. BOX 828, BLOOMFIELD HILLS, MI, 48303, US

(73) Assignee: Carl Freeudenberg KG, Weinheim (DE)

(21) Appl. No.: 10/491,455

(22) PCT Filed: Jun. 26, 2002
(86) PCT No.: PCT/EP02/07035

(30) Foreign Application Priority Data
Oct. 2, 2001 (DE) 101 48 715.0

(51) Int. Cl. F16J 15/32

(52) U.S. Cl. 277/549

(57) ABSTRACT

A radial shaft seal with a sealing element made of a non-woven fabric impregnated with an active material, particularly PTFE. The shaft seal is disposed between a stationary machine part and a rotating shaft. In the axial direction, the sealing element consists of at least one layer of non-woven fabric impregnated with a PTFE dispersion and laminated under pressure and heat.

### CROSS-REFERENCE TO RELATED APPLICATIONS

This application is a National Stage of International Application No. PCT/EP02/07035, filed Jun. 26, 2002. This application claims the benefit of German Patent Application 101 48 715.0, filed Oct. 2, 2001. The disclosures of the above applications are incorporated herein by reference.

### FIELD OF THE INVENTION

Numerous seals are known for sealing shafts that rotate within a stationary housing. Frequently used are seals known as lip seals involving a lip-shaped sealing element made of an elastomer that surrounds the shaft in a sealing manner. With aggressive media, sealing lips made of a PTFE material are also in use. To complement the seals, dirt-collecting aprons consisting of a simple felt disk are often used on the air side. If the dirt-collecting aprons are extended as far as the shaft, they additionally have a sealing function. This, however, results in a marked increase in the frictional moment of torque of the overall system.

To reduce the frictional moment of torque of the sealing system, the space between the sealing lip and the dirt-collecting apron is often filled with grease.

Sealing lips made of PTFE generally generate lower frictional forces. In this respect, their use for an intended reduction of frictional forces is advantageous. Such seals, however, have the drawback that PTFE has a tendency to creep, particularly at high temperatures, which can cause tension losses and thus leaks. For this reason, pure PTFE is only rarely used as a sealing lip material for shaft seals. Expensive compositions are used from which shape-retaining sealing lips are obtained by cost-intensive sintering processes and mechanical processing steps.

### SUMMARY OF THE INVENTION

The object of the invention is to provide a radial shaft seal with good sealing properties, particularly during long-term use, that generates low frictional forces and that can also be economically fabricated.

In the case of a radial shaft seal with a sealing element made of a non-woven fabric impregnated with an active material, particularly PTFE, and disposed between a stationary machine part and a rotating shaft, this objective can be reached in that the sealing element, at least in the axial direction, consists of at least one layer of non-woven fabric impregnated with a PTFE dispersion (including fillers) and laminated under pressure and heat. In this manner, it is possible-to obtain a sealing element with unusually low frictional forces by a laminating process for the non-woven fabric web or webs (pressure and heat) specifically adapted to the processing conditions/medium and shaft displacement. This is because, at low lamination pressure and temperature, the sealing lip remains flexible so that it can readily accommodate shaft displacement and adapt itself to the shaft surface, whereas at high lamination pressure and temperature a mechanically highly stable and, in particular, oil-tight sealing lip is produced. This can also be achieved by lamination of non-woven fabrics impregnated with different PTFE dispersions and fillers. The number of non-woven fabric layers can be varied as desired.

The non-woven fabric is preferably impregnated with an aqueous PTFE dispersion. This dispersion can also contain inorganic fillers. Particularly good results are obtained when the PTFE dispersion contains up to 50 wt. %, of graphite, talc, mica or molybdenum disulfide, based on the dry weight of PTFE as the organic filler.

A preferred non-woven fabric is a mechanically bonded one. The mechanical bonding of the non-woven fabric can be accomplished, for example, by water-jet bonding or needling. This provides good mechanical support as well as an open structure and porosity. Moreover, the non-woven fabric can be made of fibers or fiber blends of polyamide, polybenzimidazole, polyester, glass fibers, aramide fibers, polyacrylic fibers or basalt fibers. The fibers, preferably, are 2-100 mm and particularly 3-20 mm long and have a weight per unit area of 20 to 500 g/m². The relative shortness of the fibers ensures high porosity which is advantageous for the subsequent impregnation.

To obtain an oil-tight sealing lip, it is necessary, after the impregnation step, to undertake an appropriate densification and bonding of the PTFE flocks that are loosely anchored in the non-woven matrix.

To this end, in an additional processing step, the PTFE non-woven fabric sealing web is subjected in a continuous rolling or lamination process, with the aid of rotating, heated steel rollers, to a heat and pressure treatment which on one side results in marked densification of the PTFE non-woven fabric web (highly oil-tight) and at the same time, because of the spreading action of the rollers, leads to marked surface smoothing. This results in improved frictional behavior, lower dirt exposure and no inclusion into the sealing lip of dust and dirt particles from the outside or of carbonized oil particles from the inside.

The sealing elements themselves are fabricated by punching them out of the laminated non-woven fabric webs. To complete the radial shaft seal, the elements are connected to fastening elements which in themselves are known and are inserted into appropriate housing openings. For this purpose, the sealing element is provided with an annular disk having a fastening collar and a sealing hub forming the sealing surface. The sealing hub that rests on the shaft is configured so that it provides a certain overlap. As a result of this overlap, the sealing hub resting on the shaft is readily bent when it is pulled onto the shaft. In case of a larger overlap, it may be advantageous to press the sealing hub against the shaft by a coiled spring. For protection of the coiled spring against particle inclusions, the spring can also be completely enveloped by a highly flexible non-woven fabric web.

The sealing elements can also be configured as dust protectors. As a result of the low frictional coefficient of the new sealing element, the dust protector can, with its inner edge, be in contact with the shaft without thus causing an undesirably high frictional moment of torque. The method of producing the radial shaft seal with a sealing element made of a non-woven fabric impregnated with an active material, particularly PTFE, and disposed between a stationary machine part and a rotating shaft is characterized in that mechanically bonded non-woven fabric webs made of fibers having a length of 3-100 mm and particularly 3 to 20 mm are impregnated with an aqueous PTFE dispersion, then dried, and finally a predetermined number of the webs is laminated either individually or to each other by use of heat and pressure. It is advantageous if, after impregnation, the non-woven fabric webs are passed between squeeze rollers.

The non-woven fabric webs used have a thickness of less than 2.5 mm and preferably from 0.5 to 1.25 mm. The drying of the impregnated non-woven fabric webs can be carried out in a continuous oven at a temperature from 30 to 300° C.

Lamination of the non-woven fabric webs brings about a 10 to 75% densification of the webs, based on their starting thickness.

The sealing elements can be punched out of the laminated non-woven fabric webs in any desired size or shape. The resulting sealing elements are then subjected to a sintering treatment at elevated temperature and elevated pressure.

In special cases, the sealing surfaces of the sealing element can be subjected to an additional, separate post-treatment to obtain a layer that is more highly wear-resistant and/or more highly densified. This post-treatment can also consist of partial embossing and/or post-sintering of channels to produce hydrodynamic transport-promoting structures.

In another special case, a hydrodynamic transport-promoting structure can be created by pulling the sealing element over a mandrel having a rough surface. In this manner, fibers are partly pulled out of the non-woven fabric—PTFE composite in the future zone of contact with the shaft. With their pulled-out part, these fibers orient themselves in a manner depending on the direction of shaft rotation, and as a result the medium to be sealed off and that had penetrated into the sealing gap is returned to the space to be sealed. The fibers thus act as return elements (spin elements) that are independent of the direction of shaft rotation.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the following, the invention will be explained in greater detail by way of the embodiments represented in the drawings, in which:

FIG. 1 shows the cross-section of a radial shaft seal according to a principal of the present invention with a sealing element and a dirt collecting apron,

FIG. 2 shows the cross-section of a radial shaft seal according to a principal of the present invention with a sealing element and a bent sealing hub,

FIG. 3 shows the cross-section of a radial shaft seal according to a principal of the present invention with a post-treated sealing hub with higher wear resistance and return channels,

FIG. 4 shows the cross-section of a radial shaft seal according to a principal of the present invention with two sealing elements disposed one after the other and kept at a distance from one another by an element forming a grease border toward the shaft, and

FIG. 5 is a top view of the sealing surface of a sealing element with transport-promoting fibers partly pulled out of the nonwoven fabric—PTFE composite.

### DETAILED DESCRIPTION OF THE PREFERRED EMBODIMENTS

The following description of the preferred embodiment(s) is merely exemplary in nature and is in no way intended to limit the invention, its application, or uses.

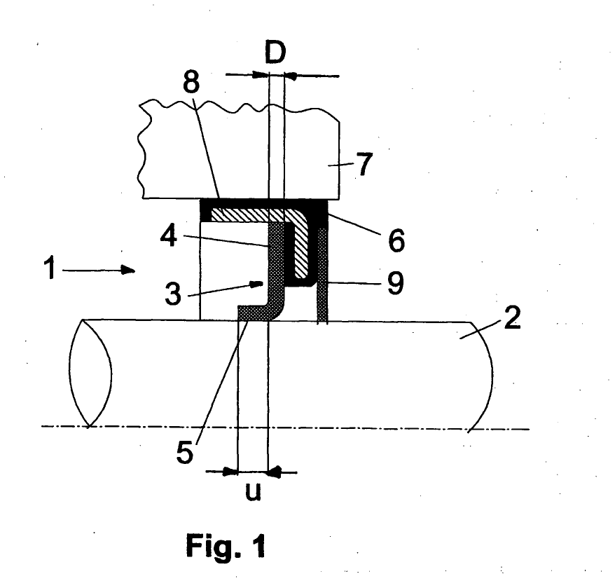

Radial shaft seal 1 shown in FIG. 1 is provided with a sealing element 3 that rests on a shaft 2. The sealing element consists of least one layer of a non-woven fabric impregnated with a PTFE dispersion that is laminated under pressure and heat. The sealing element 3 is an annular disk and has a fastening collar 4 and a sealing hub 5 that form a sealing surface. By means of the fastening collar 4, the sealing element 3 is fastened in a housing 7 by an elastomer 6.

Inserted into the elastomer 6 is a stiffening ring 8 made of metal. Moreover, a dirt-collecting apron 9 is provided on the outer side of the radial shaft seal 1 on the elastomer 6. A radial shaft seal configured in this manner has an extremely low friction coefficient, even though the overlap U provided by the sealing hub 5 is about twice as thick as a thickness D of the sealing element 3. Furthermore, dirt-collecting apron 9 rests on shaft 2. The dirt-collecting apron 9, like the sealing element 3, consists of one or several layers of a compressed non-woven fabric. The sealing hub 5 is obtained by folding the inner annular disk.

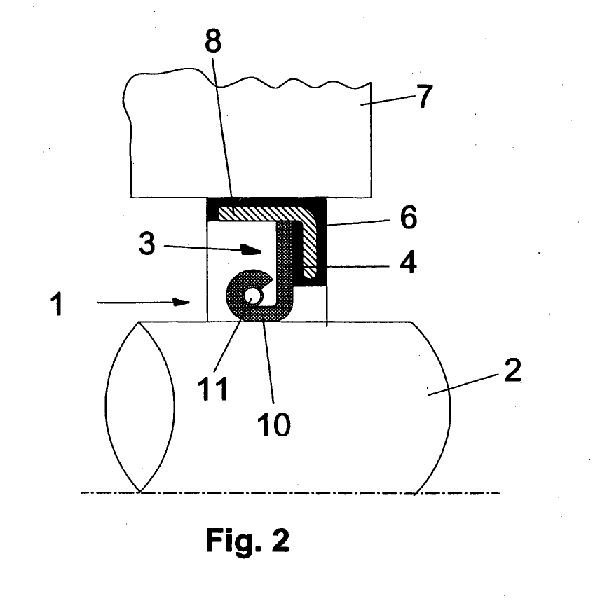

FIG. 2 shows a radial shaft seal 1 with a sealing element 3 that has a sealing hub 10 which is pressed against the shaft 2 by a coiled spring 11 and which embraces the coiled spring over more than 180°. Such a radial shaft seal is particularly well suited for long-term use. The fastening collar 4 of the sealing element 3 is inserted into the housing 7 with the aid of an elastomer 6 and the metal reinforcement provided therein.

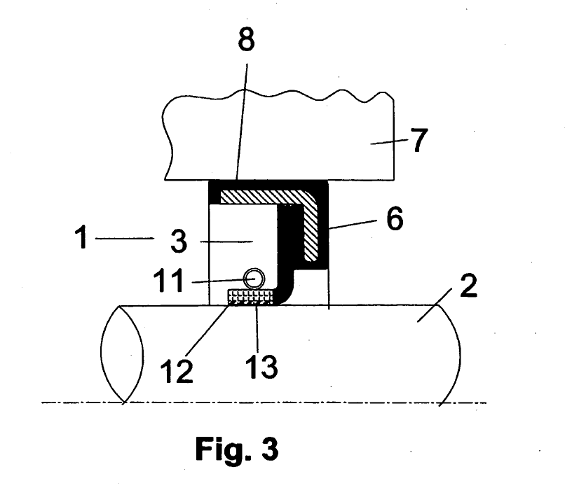

FIG. 3 shows an embodiment of a radial shaft seal 1 wherein, on its sealing surface 13, a sealing hub 12 has channels or recesses bringing about a return of the medium to be sealed off to the space to be sealed. These channels are introduced into the sealing element 3 by a partial embossing at an elevated temperature and pressure. Here, too, it is advantageous to use a coiled spring 11. The fastening of the sealing element 3 to the support that consists of the elastomer 6 and reinforcing ring 8 in the housing 7 is brought about in the same manner as in FIG. 2.

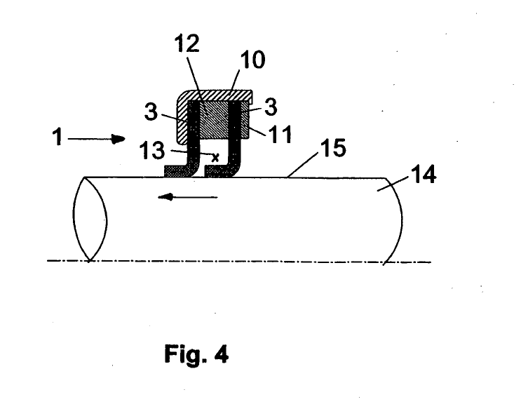

FIG. 4 shows, in the last fabrication stage, a radial shaft seal 1 with two sealing elements 3 disposed one after another. The two sealing elements are separated from each other by a spacer ring 12. Toward the shaft, the spacer ring 12 forms an edge around a space 13 which can be filled with grease. The grease forms a barrier to dirt penetration from the outside and lubricates the sealing element 3.

The outer sealing element is supported by a disk 11 surrounded by metal housing 10. The last-presented fabrication step involves pulling a mandrel 14 through the radial shaft seal 1 in the direction indicated by the arrow. The mandrel 14 has a rough surface 15 capable of pulling the fibers partly out of the non-woven fabric—PTFE composite. In the case presented here, the mandrel 14 has a slightly smaller diameter than the shaft to be sealed. As a result, transport-promoting fibers are produced only in the region of the contact surface facing the oil side.

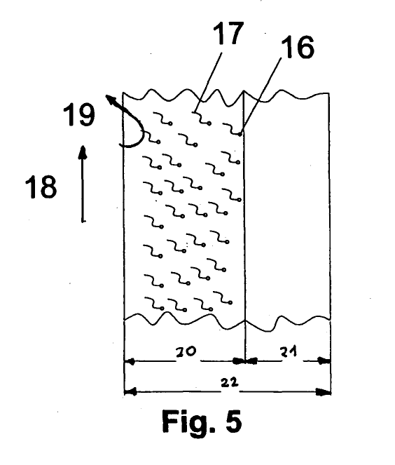

FIG. 5 shows a top view of the sealing surface 22 of the radial shaft seal of FIG. 4. In a region 20 facing the oil side, fibers 17 are partly pulled out of the non-woven fabric—PTFE composite so that their end 16 is still anchored.

The fibers 17 orient themselves depending on the relative motion 18 of the shaft. In this manner, independently of the direction of shaft rotation, a liquid 19 that has penetrated into the seal gap is returned to the space to be sealed off. A region 21 of a sealing surface 22 that faces away from the space to be sealed is free of pulled-out fibers and remains smooth.

### EXAMPLE

To prepare a radial shaft seal, 1.0-mm-thick non-woven fabric webs were made from 8-15 mm-long fibers. The non-woven fabric webs were impregnated with an aqueous PTFE dispersion and then passed through squeeze rollers. They were then dried in a continuous oven at a temperature of 260° C. and laminated in a compressing apparatus. Annular sealing elements were punched out of the resulting laminate and inserted into a shaft seal. The radial shaft seal was pushed over a shaft, the diameter of which was slightly larger than the inner diameter of the sealing element opening. This resulted in a slight bending of the sealing element edge, the overlap amounting to about 1.5 mm. The performance of the seal in terms of friction and tightness was surprisingly good.

The description of the invention is merely exemplary in nature and, thus, variations that do not depart from the gist of the invention are intended to be within the scope of the invention. Such variations are not to be regarded as a departure from the spirit and scope of the invention.

1. A radial shaft seal comprising a sealing element made of a non-woven fabric impregnated with an active material disposed between a stationary machine part and a rotating shaft, wherein, in an axial direction, the sealing element consists of at least one layer of non-woven fabric impregnated with a PTFE dispersion that is laminated under pressure and heat.

2. The radial shaft seal according to claim 1, wherein the layers of non-woven fabric are impregnated with an aqueous PTFE dispersion.

3. The radial shaft seal according to claim 2, wherein the PTFE dispersion contains inorganic fillers.

4. The radial shaft seal according to claim 2, wherein the PTFE dispersion contains as inorganic filler up to 50 wt. % of graphite, talc, mica or molybdenum disulfide, based on a dry weight of PTFE.

5. The radial shaft seal according to claim 1, wherein the layers of non-woven fabric consist of mechanically bonded non-woven fabric having a fiber length of 3 to 100 mm and a weight per unit area of 20-500 g/m².

6. The radial shaft seal according to claim 5, wherein the mechanical bonding of the non-woven fabric is achieved by water-jet bonding or needling.

7. The radial shaft seal according to claim 1, wherein the non-woven fabric consists of fibers or fiber blends of polyamide, polybenzimidazole, polyester, glass fibers, aramide fibers, polyacrylic fibers or basalt fibers.

8. The radial shaft seal according to claim 1, wherein the sealing elements consists of an annular disk with a fastening collar and a sealing hub forming the sealing surface, and at the shaft, the sealing hub forms an overlap of at least 1 mm and preferably 2 mm.

9. The radial shaft seal according to claim 8, wherein the sealing hub is formed by bending the inner annular disk.

10. The radial shaft seal according to claim 8, wherein the sealing hub is pressed against the shaft by a coiled spring.

11. The radial shaft seal according to claim 1, wherein the sealing element is configured as a dust protector.

12. The radial shaft seal according to claim 11, wherein with an inner edge, the dust protector rests on the shaft.

13. A method of producing a radial shaft seal with a sealing element made of a non-woven fabric impregnated with an active material, the sealing element being disposed between a stationary machine part and a rotating shaft, comprising:
mechanically bonding non-woven fabric webs made from 3 to 100-mm long fibers;
impregnating the non-woven fabric webs with an aqueous PTFE dispersion;
drying the impregnated non-woven fabric webs; and
laminating a predetermined number of the webs by use of heat and pressure.

14. The method according to claim 13, wherein after impregnation the non-woven fabric webs are passed through squeeze rollers.

15. The method according to claim 13, wherein the non-woven fabric webs used have a thickness of less than 2.5 mm.

16. The method according to claim 13, wherein the drying of the impregnated non-woven fabric webs is carried out in a continuous oven at a temperature ranging from 30 to 300° C.

17. The method according to claim 13, wherein during the lamination of the non-woven fabric webs, the individual webs are densified to an extent of 10 to 75% of their starting thickness.

18. The method according to claim 13, wherein the sealing elements are punched out of the laminated non-woven fabric webs in a predetermined size and shape.

19. The method according to claim 13, wherein the sealing element is subjected to a sintering treatment at an elevated temperature and elevated pressure.

20. The method according to claim 13, wherein in the region of its sealing surfaces, the sealing element is subjected to a separate post-treatment and has wear-resistant and/or densified layer.

21. The method according to claim 20, wherein the post-treatment consists of a partial embossing and/or a post-sintering.

22. The method according to claim 13, wherein in a finished condition, the radial shaft seal is pulled over a mandrel.

23. The method according to claim 21, wherein the mandrel has a smaller diameter than the shaft to be sealed with the radial shaft seal.
